(19) United States
(12) Patent Application Publication
(10) Pub. No.: US 2010/0257565 A1
(43) Pub. Date: Oct. 7, 2010

(54) METHOD AND SYSTEM FOR RADIO-BASED BROADCAST OF A VIDEO SIGNAL

(75) Inventor: Carlos Lucas, Zaragoza (ES)

Correspondence Address: KACVINSKY DAISAK PLLC, 4500 BROOKTREE ROAD, SUITE 302, WEXFORD, PA, 15090, US

(73) Assignee: BENQ MOBILE GMBH & CO. OHG, Muenchen (DE)

(21) Appl. No.: 12/161,308

(22) PCT Filed: Jan. 15, 2007
(86) PCT No.: PCT/EP2007/050360

§ 371 Date: Jun. 21, 2010

(30) Foreign Application Priority Data
Jan. 17, 2006 (DE) 10 2006 002 265.3

(51) Int. Cl. H04N 7/173

(52) U.S. Cl. 725/62

(57) ABSTRACT

A mobile communication appliance (10) sets up a connection to a coordination device (20) via a first mobile radio link (12, 21). This is used to register a request for participation in a radio-based video chat. The mobile communication appliance (10) receives a participation confirmation and records a video signal. The latter is transmitted to a video server (30) via a second mobile radio link (13) for storage. Finally, the mobile communication appliance (10) transmits a message to the coordination device (20), with the message containing a reference to the video signal stored on the video server (30). This reference is forwarded to a transmission station (40), from which the video signal is broadcast as a radio signal (45).

The invention relates to a method and a system for radio-based broadcast of a video signal.

Participation of users in discussion groups with the assistance of electronic means, so-called chats, has become very popular. There are many possibilities for participating in chats on the Internet but the options available to the group of cellular telephone subscribers are also increasing. Chats among multiple cellular telephone subscribers are possible, for which purpose only mobile communication devices such as cellular telephones are used, but also interaction among subscribers with mobile communication devices via TV shows is also possible.

There are various methods for participating in chats. One method is the so-called video chat wherein a person can participate in a discussion group by using a microphone and a small camera, a so-called web cam, in Internet-based approaches; in the discussion group, the audio signals and the video signals of the participants are made available for all the participants via the Internet almost in real time. For cellular telephone subscribers, TV shows are offered in which the subscriber sends a text-based short message, e.g., an SMS, from his cellular telephone to the television studio. The text of this short message is then displayed as text with the television image or is read by an artificial figure, an avatar, which is generated by computer animation, for example.

Digital cameras are also integrated into or can at least be connected to many cellular telephones today. To an increasing extent, short video signals than therefore also be recorded. With cellular telephone devices of the third generation, e.g., according to the Universal Mobile Telecommunications System (UMTS) standard, higher data transmission rates are also possible to an increasing extent. This also yields the possibility of exchanging not only text messages but also video messages. Consequently, there is also a desire to exchange video messages via a radio-based video chat, in which the video messages are broadcast via a television set for example.

Such a chat addresses a large public and prompts many viewers to participate, so there could be a high data volume due to the video signals to be transmitted and there could be an increased demand for transmission capacity, in particular on the part of the operator of the chat. Furthermore participation should be as uncomplicated as possible for a user and a high data volume due to unnecessary transmissions should be avoided.

The object of the present invention is to provide a method with which a video signal can be broadcast by a mobile communication device in a radio-based process whereby transmission of video data takes place in a flexible manner and with a low required transmission capacity. Another object of the invention is to provide a system with which a radio-based transmission of a video signal from a mobile communication device is possible in a flexible manner and with a low data volume.

These objects are achieved in the subjects of the independent patent claims 1 and 12. Embodiments and refinements of the invention are the subject matter of the dependent claims.

With regard to the method, the object is achieved by a method for radio-based broadcast of a video signal comprising the steps:

Establishing a connection from a mobile communication device to a coordination device via a first cellular telephone link;

Communicating a request to participate from the mobile communication device to the coordination device via the first cellular telephone link;

Receiving a confirmation of participation from the coordination device through the mobile communication device via the first cellular telephone link;

Detecting the video signal comprising an image sequence with audio data;

Transmitting the video signal via a second cellular telephone link from the mobile communication device to a video server for storage of the video sequence of the video signal on the video server;

Transmitting a message from the mobile communication device to the coordination device whereby the message contains a reference to the video signal stored on the video server;

Forwarding the reference from the coordination device to a transmitting station;

Broadcast of the video signal as a radio signal by the transmitting station.

A user who would like to participate in a radio-based video chat, for example, will establish with his mobile communication device, e.g., a cellular telephone, a connection to a coordination device which may be in a television studio, for example. The link is established via a first cellular telephone link. The user directs a request for participation in the video chat to the coordination device after the link is established. In this way the coordination device has the information that a video signal is to be expected from the mobile communication device. The participation request from the mobile communication device is confirmed by the coordination device via the first cellular telephone link. The user receives a video signal and transmits it to a video server via a second cellular telephone link for storage of the video signal. The video signal comprises a sequence of images with the respective audio data. By means of a message, the coordination device is provided with a reference to the video signals stored on the video server by the mobile communication device, e.g., a storage location or a filename under which the video signal is stored. The coordination device forwards this reference to a transmitting station which then broadcasts the video signal via a radio signal, e.g., a TV channel. To do so, the transmitting station accesses the video server with the reference and is able in this way to process the content of the video signal.

By dividing the transmission from the mobile communication device to the coordination device and the video server, the transmission capacities which must be kept on standby by the transmitting station are minimized. Due to the independence of the video server from the coordination device, broadcast of the video signal can be handled in a flexible manner.

In one aspect of the present invention, after the message of a participation request from the mobile communication device by the coordination device, a check is performed on whether a time window can be reserved for broadcasting the video signal. The coordination device manages the time windows available for broadcasting video signals. The video signals may be limited in time, e.g., to five seconds. In the case of an available time window, it is reserved for the mobile communication device and a positive confirmation of participation is transmitted to the mobile communication device. If no time window is available, a negative confirmation of participation is transmitted. The mobile communication device evaluates the confirmation of participation. In the case of a positive confirmation, a video signal is acquired and transmitted to the video server for storage. If the confirmation is negative, no video signal is transmitted, which reduces the data volume in the cellular wireless network. Acquisition of video signals can also be suppressed in the event of a negative confirmation.

In one aspect of the present invention, the transmission of the message takes place via a text-based short message, e.g., Short Message Service or SMS. In another aspect of the present invention, the video signal is received by a camera integrated into the mobile communication device. Then both images and sound are recorded. To record sound, a microphone, which is present in the mobile communication device anyway, is used.

The video signal may be transmitted in various ways. The transmission of the video signal to the video server may take place via a packet-oriented transmission technology. This is understood to include in particular the transmission using a protocol from the TCP/IP protocol family. This protocol family, which is conventional on the Internet, is also being incorporated to an increasing extent into the area of mobile telecommunications. For example, Internet protocol (IP) packets are sent to the video server via the second mobile wireless link. The Internet address of the video server may be permanently stored in the mobile communication device, for example, or may be transmitted by the coordination device in the confirmation of participation or may be entered by the user in some other way.

In an alternative possibility of transmission of the video signal, an H.324-based protocol may be used. H.324 is an ITU-T recommendation which describes the terminals for the multimedia communication with low bit rates. One area of application for this recommendation is video telephone technology in which video data are exchanged between two subscribers. And expansion of this recommendation is H.324M with which cellular telephone devices of third generation should be included. A corresponding protocol for this is the 3G-H.324M protocol. The video signal is thus transmitted to the video server as in a video telephone link in which no video data is transmitted back from the video server.

Another possibility for transmission of the video signal is to embed it in at least one multimedia message of the multimedia messaging service or MMS. MMS is a multimedia messaging service which forms an expansion of the short message service SMS for mobile communication devices and is made available by such. In this case, the video signal is sent in one multimedia message or, if the size is larger, divided into several multimedia messages. The receiver is then the video server. For example the multimedia messages are characterized with an index which is later transmitted as a reference to the coordination device.

As with packet-oriented transmission technology, the address and/or number of the video server may also be stored in the mobile communication device in transmission according to the H.324-based protocol or via multimedia messages, or transmitted by the coordination device or entered in some other way. Due to the various transmission possibilities which may also be available concurrently, participation in a video chat can be handled in a very flexible manner. In all cases, the video signal is transmitted in coded form.

In one aspect of the present invention, the step of transmission of the video signal begins during the step of acquisition of the video signal. Thus there is almost no delay due to receipt of the video signal, which is then available for broadcast almost immediately after the end of reception on the video server. Only the signal transit time in transmission of the video signal and the transmission of the message with the reference need be taken into account. Broadcast of the video signals may take place virtually live and thus allows approximately an interactivity among the participants in the video chat.

In another aspect, the video signal is broadcast as a radio signal alone or together with other video signals, each embedded in one partial area of a television image. The video signal may thus be embedded in an animated television image such as a cartoon. This is advantageous in particular when the resolution of the video signal, e.g., 176×144 pixels, is much lower than the resolution of the television image, and enlarging the video signal to television format, e.g., 720×576 pixels, cannot yield satisfactory quality.

If the capacity of the camera and the mobile wireless link are adequate, the video signal may also be broadcast as a full screen, i.e., the video signal is enlarged to the resolution of the television image and completely fills up the available image area.

In another aspect of the invention, a display system is provided with which the video signal can be displayed before being broadcast, e.g., in the transmitting station. This allows, for example, a check on whether a video signal has been transmitted correctly, e.g., to prevent the broadcast of a defective television image. Furthermore, this makes it possible to monitor the content of the video signal to filter out video signals with content considered unsuitable for broadcasting, for example.

With regard to the system, this object is achieved by a system for radio-based broadcast of a video signal that comprises a video server, a coordination device, a camera, a mobile communication device and a transmitting station. The video server is designed for storing a video signal. The function of the coordination device consists of receiving a request for broadcast of the video signal as a radio signal, sending a confirmation for the broadcast in response to the request, receiving a message with a reference to the video signal stored on the video server and forwarding the reference to the transmitting station. The mobile communication device is designed for transmitting the request and receiving the confirmation via a first mobile wireless link. Another object of the mobile communication device is to transmit the video signal recorded by the camera to the video server via a second mobile wireless link and to transmit the message with the reference to the video signal stored on the video server. The transmitting station is designed for receiving the reference from the coordination device and for broadcasting the video signal as a wireless signal.

With the system described here, a user having a mobile communication device can establish a connection to a coordination device in order to make a participation request for a video chat, for example. The coordination device may send back a confirmation of participation, which under some circumstances also contains the address or number of a video server to which a video signal is to be transmitted. A video signal recorded with a camera is transmitted over a second mobile wireless link to the video server, whereby a reference to the video signal is transmitted with a message to the coordination device. The reference is forwarded to a transmitting station which broadcasts the video signal as a radio signal, e.g., over a TV channel.

The modular design of the system through the individual elements allows flexible operation. For example, the coordination device, the video server and the transmitting station may be provided separately from one another in space. By transmitting a confirmation of participation, which may also be negative, it is possible to prevent unnecessary transmission of a video signal and thus minimize the data volume.

In one aspect of the present invention, the mobile communication device should be capable of transmitting the message as a text-based short message. In another aspect of the invention, the camera is integrated into the mobile communication device.

The transmitting station may broadcast the video signal either as a full screen or alone or together with other video signals embedded each in a partial area of a television image. In another aspect of the invention, the system may comprise a display system which is designed for displaying the video signal before a broadcast. The broadcast of the television image by the transmitting station may be transmitted in a known analog or digital standard via terrestrial television, cable television or satellite television. However, the broadcast may also be via a data streaming on the Internet, or so-called Internet TV.

The present invention is explained in greater detail below on the basis of exemplary embodiments with reference to the drawings.

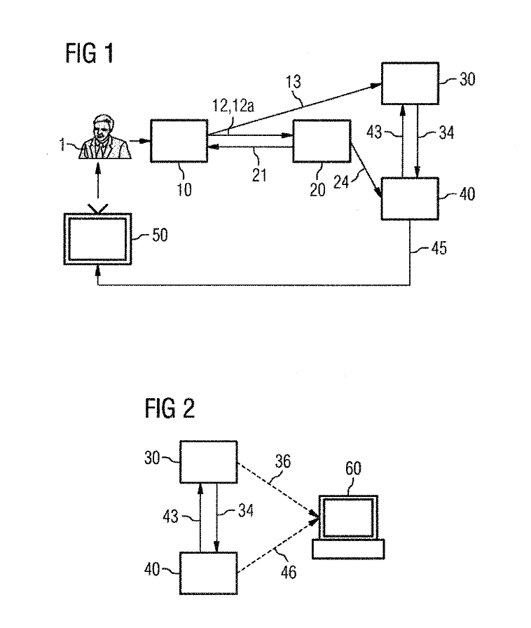

FIG. 1 shows an exemplary embodiment of the inventive system,

FIG. 2 shows an exemplary embodiment of the arrangement of the inventive display system,

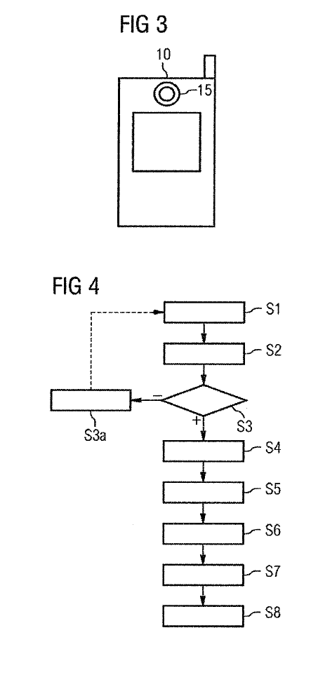

FIG. 3 shows an exemplary embodiment of a mobile communication device with an integrated camera,

FIG. 4 shows a flow chart for the inventive method,

FIG. 5 shows a first exemplary embodiment of the broadcast of the video signals,

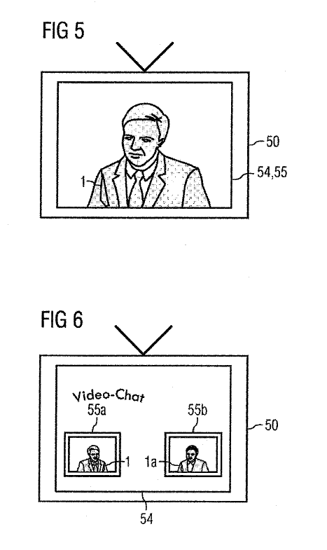

FIG. 6 shows a second exemplary embodiment of the broadcast of the video signals.

FIG. 1 illustrates an exemplary embodiment of the inventive system which may be used, e.g., for a radio-based video chat. A subscriber 1 uses his television set 50. He has access to his mobile communication device 10. Furthermore, the coordination device 20, the video server 30 and the transmitting station 40 are also shown. To participate in the video chat, a first mobile wireless link 12 is established from the mobile communication device 10 to the coordination device 20 and a subscriber request is reported. The coordination device sends a confirmation of participation to the mobile communication device 10 via a channel of the first mobile wireless link 21. This confirmation reports, for example, approval of participation and an address and/or number of the video server 30.

The mobile communication device 10 then establishes a link 13 to the video server 30 and transmits a video signal, which is received with a camera 15 integrated into the mobile communication device 10, for example. A mobile communication device 10 with an integrated camera 15 is shown in FIG. 3, for example.

A reference to the video signal stored on the video server 30 is transmitted to the coordination device 20 via a message 12a. The coordination device 20 relays this reference via a link 24 to the transmitting station 40. With this information, the transmitting station 40 queries the video signal via a link 43 on the video server 30, which transmits it via a link 34 to the transmitting station 40 from which it can be broadcast over a radio signal 45 and can be received on the television set 50 of the subscriber 1. Coordination device 20, video server 30 and transmitting station 40 may be set up in the immediate velocity of one another, e.g., in a television station. However, according to the proposed principle, a spatial separation of the three components is also possible. This allows flexible operation for the video chat because the video server 30 can be replaced easily, for example, for reasons of redundancy or capacity. The video server need not be a stand-alone device but instead may also be designed as a cluster, i.e., as a combination of several individual devices that act together as a single device.

FIG. 2 shows an exemplary embodiment of a display system 60 in combination with a video server 30 and a transmitting station 40. Components having the same function and/or effect are labeled with the same reference numerals.

The video signals may be checked via the display system 60 before being broadcast. To do so, a video signal is acquired directly from the video server 30 either via the dotted line connection 36 or from the transmitting station 40 via the link 46. The display system 60 allows visual monitoring of whether a video signal can be broadcast without error. Furthermore it also allows a review of the content of the video signals.

FIG. 4 shows a flow chart for the inventive method. In step S1, a link to the coordination device 20 is established from the mobile communication device 10. In step S2 the coordination device 20 receives a participation request from the mobile communication device 10. This is done via a first mobile wireless link. In step S3 the coordination device 20 checks on whether a time window can be reserved for broadcast of the video signal. If a time window is no longer available, the coordination device 20 sends a negative confirmation of participation to the mobile communication device 10 in step S3a. In this case, it is possible to jump back to step 1 to send a renewed participation request.

In the event a time window has been reserved, then in step S4 a positive confirmation of participation is sent to the mobile communication device 10 whereupon this begins to detect and transmit the video signal to the video server 30. The video signal may be sent immediately after the end of reception or directly during reception. When the transmission of the video signal to the video server 30 is ended, then in step S5 a message with a reference to the stored video signal is transmitted to the coordination device 20. This reference is forwarded in step S6 from the coordination device 20 to the transmitting station 40. In step S7, the transmitting station 40 retrieves the stored video signal from the video server 30 with the reference. In step S8 the video signal is processed and broadcast as a radio signal. The broadcast of the video signal may take place as a full screen or embedded in partial areas of a television image alone or together with other video signals.

An example of a broadcast as a full screen is shown in FIG. 5. In a television set 50, a video signal showing the subscriber 1 is sent as a full screen 55 which fills up the entire television image 54.

If the resolution of the video signals does not allow magnification to a full screen of a satisfactory quality, video signals may also be shown in partial areas of the television image 54. This is depicted in FIG. 6. The television image 54 which is displayed in the television set 50 shows two details 55a and 55b, in which video signals of subscribers 1 and 1a are running. The background of the television image 54 here is depicted with lettering and two television sets are indicated.

With the inventive principle, participation in a radio-based video chat can take place in a very flexible manner because mobile communication devices with different technological equipment may be used due to the different transmission options for the video signals. Furthermore, multiple video servers may be used, e.g., a separate server for each type of transmission offered. In addition, it is possible to distribute the data volume among multiple links, so that only a low transmission capacity need be kept on reserve in each case or it is switched on only as needed.

1. A method for radio-based broadcast of a video signal, comprising:
establishing a link from a mobile communication device to a coordination device via a first mobile wireless link;
communicating a participation request from the mobile communication device to the coordination device via the first mobile wireless link;
receiving a confirmation of participation from the coordination device through the mobile communication device via the first mobile wireless link;
detecting the video signal, comprising an image sequence with audio data;
transmitting the video signal over a second mobile wireless link from the mobile communication device to a video server for storage of the video signal on the video server;
transmitting a message from the mobile communication device to the coordination device the message including a reference to the video signal stored on the video server;
forwarding the reference from the coordination device to a transmitting station; and
broadcasting the video signal through a transmitting station as a radio signal.

2. The method according to claim 1, wherein
after the step of communicating a participation request from the coordination device a check is performed to ascertain whether a time window can be reserved for broadcast of the video signal;
the confirmation of participation is positive or negative as a function of the check; and
detection and transmission of the video signal is performed based on the confirmation of participation.

3. The method according to claim 1, wherein the message comprises a text-based short message.

4. The method according to claim 1, wherein the video signal is detected with a camera integrated with the mobile communication device.

5. The method according to claim 1, wherein the transmission of the video signal is performed using packet-oriented transmission.

6. The method according to claim 1, wherein the transmission of the video signals is based on an H.324-based protocol.

7. The method according to claim 1, wherein the transmission of the video signal is performed by a multimedia messaging service.

8. The method according to claim 1, wherein transmission of the video signal begins during acquisition of the video signal.

9. The method according to claim 1, wherein the video signal is broadcast embedded in a partial area of a television image.

10. The method according to claim 1, wherein the video signal is broadcast as a full screen.

11. The method according to claim 1, further comprising displaying the video signal with a display system before the broadcast.

12. A system for radio-based broadcast of a video signal, comprising:
a camera for a acquiring the video signal;
a video server for storing the video signal;
a coordination device for receiving a request for broadcast of the video signal as a radio signal, sending a confirmation for broadcast in the response to the request, receiving a message with a reference to the video signal stored on the video server, and forwarding the reference;
a mobile communication device for transmitting the request and receiving the confirmation via a first mobile wireless link, transmitting the video to the video server via a second mobile wireless link, and transmitting the message with the reference to the stored video signal; and
a transmitting station for receiving the reference from the coordination device and for broadcasting the video signal as a radio signal.

13. The system according to claim 12, wherein the mobile communication device is designed to transmit the message as a test-based short message.

14. The system according to claim 12, wherein the camera is integrated with the mobile communication device.

15. The system according to claim 12, wherein the transmitting station is designed to broadcast the video signal alone or together with other video signals embedded each in one partial area of a television image.

16. The system according to claim 12, wherein the transmitting station is designed to broadcast the video signal as a full screen.

17. The system according to claim 12, further comprising a display system designed to display the video signal before broadcasting.

18. A mobile communication device configured to:
establish a link to a coordination device via a first mobile wireless link;
communicate a participation request to the coordination device via the first mobile wireless link;
receive a confirmation of participation from the coordination device via the first mobile wireless link;
detect a video signal comprising an image sequence with audio data;
transmit the video signal over a second mobile wireless link to a video server for storage of the video signal on the video server; and
transmit a message to the coordination device, the message including a reference to the video signal stored on the video server, wherein the reference is forwarded from the coordination device to a transmitting station for broadcasting the video signal as a radio signal.

19. The mobile communication device of claim 18, wherein the message comprises a text-based short message.

20. The mobile communication device of claim 18, wherein the video signal is detected with a camera integrated with the mobile communication device.
